(19) United States
(12) Patent Application Publication
(10) Pub. No.: US 2020/0225712 A1
(43) Pub. Date: Jul. 16, 2020

(54) SURFACE ENHANCEMENTS FOR MOBILE DEVICE ENCLOSURES

(71) Applicant: HEWLETT-PACKARD DEVELOPMENT COMPANY, L.P., SPRING, TX (US)

(72) Inventors: KUAN-TING WU, TAIPEI CITY (TW); CHI HAO CHANG, TAIPEI CITY (TW); CHUNG HUA KU, TAIPEI CITY (TW)

(21) Appl. No.: 16/617,983

(22) PCT Filed: Jul. 17, 2017
(86) PCT No.: PCT/US2017/042384

§ 371 Date: Nov. 27, 2019

(51) Int. Cl. G06F 1/16

(52) U.S. Cl. CPC G06F 1/1681; G06F 1/1679; G06F 1/1626; G06F 1/166

(57) ABSTRACT

In example implementations, a mobile device enclosure is provided. The mobile device enclosure includes a housing to enclose a computing device and a pull-out kickstand coupled to the housing via a movable hinge. An outer perimeter of the pull-out kickstand includes a surface enhancement to increase an amount of friction on the outer perimeter of the pull-out kickstand.

### BACKGROUND

Mobile devices have enclosures that can be a clam-shell shape for some laptop computers or have pullout kickstands for 2-in-1 tablets. A user may use two hands to pull the clamshell enclosure apart to open the lap top. Similarly, a user may hold the 2-in-1 tablet with one hand and pull the kickstand out with the second hand. Thus, the current enclosure designs use two hands to open.

In addition, the current design preference is to have the enclosure appear metallic and smooth. The dimensions of the mobile devices are also getting smaller and thinner. As a result, there is less surface area to open the enclosures even when using two hands.

### BRIEF DESCRIPTION OF THE DRAWINGS

FIG. 1 is a block diagram of an isometric view of an example mobile device enclosure with a surface enhancement;

FIG. 2 is a block diagram of a side view of the example mobile device enclosure with a surface enhancement;

FIG. 3 is a block diagram of a back view of the example mobile device enclosure with a surface enhancement;

FIG. 4 is a block diagram of an isometric view of another example mobile device enclosure with the surface enhancement;

FIG. 5 is a block diagram of a side view of another example mobile device enclosure with the surface enhancement;

FIG. 6 is a block diagram of a front view of another example mobile device enclosure with the surface enhancement in a closed position; and

FIG. 7 is a flow chart of an example method for applying a surface enhancement on a mobile device enclosure.

### DETAILED DESCRIPTION

Examples described herein provide surface enhancements for mobile device enclosures and methods for applying the surface enhancements on the mobile device enclosures. As discussed above, users use two hands to open current mobile device enclosures. In addition, as the mobile device enclosures become smoother, smaller, and thinner, there is less surface area for the users to open the mobile device enclosures.

In addition, allowing a user to open the mobile device enclosure with a single hand would provide additional benefits. For example, using a single hand to open the mobile device enclosure may free the user's other hand to perform other functions. In addition, a single hand open solution would provide an overall better and easier user experience.

Examples described herein provide a surface enhancement that creates a surface with sufficient friction to allow the user to open the mobile device enclosure with a single hand. In some examples, the surface enhancement may be an application of a nano molding technology (NMT). The process may be an additive process (e.g., the surface enhancement is grown on the surface of the mobile device enclosure) or a subtractive process (e.g., the surface enhancement is etched or cut out of the mobile device enclosure). The surface enhancement may allow various different mobile device enclosures (e.g., clamshell designs, pull out kickstands, and the like) to be opened with a single hand of the user.

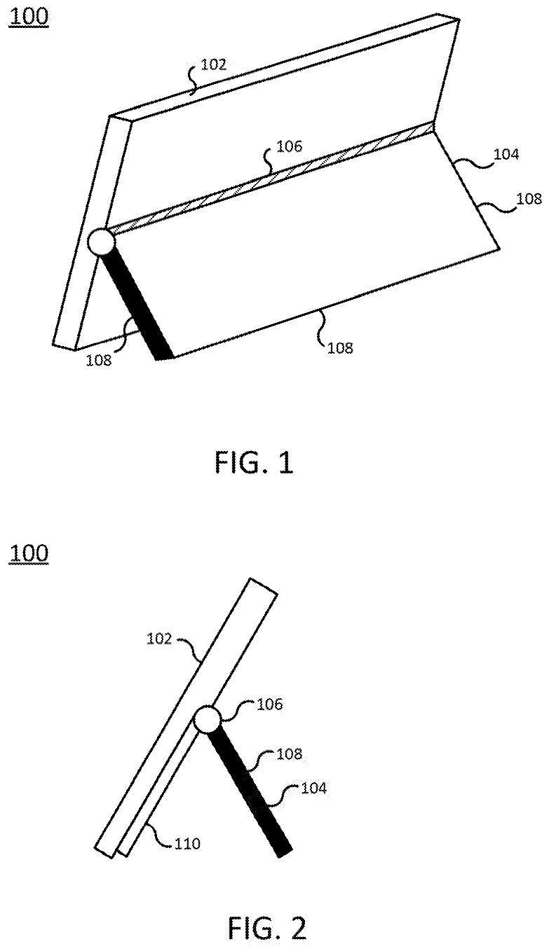

FIG. 1 illustrates a block diagram of a mobile device enclosure 100. The mobile device enclosure 100 may be a housing for a mobile computing device such as a tablet computer.

In one example, the mobile device enclosure 100 may include a housing 102. The housing 102 may have dimensions (e.g., a width, length, and thickness) that are equivalent to desired dimensions of the mobile computing device.

The housing 102 may include a pull-out kickstand 104 that is coupled to the housing 102 via movable hinge 106. The pull-out kickstand 104 may be coupled to a backside of the housing 102 that is opposite from a side that has an opening for a display of the mobile computing device. The movable hinge 106 may rotate to allow the pull-out kickstand 104 to move in a range of angles towards the housing 102 or away from the housing 102. The movable hinge 106 may have a sufficient amount of friction to allow the movable hinge 106 to maintain a desired position to support the mobile device enclosure 100 at the desired viewing angle on a surface such as a table top or a desktop.

In one example, the pull-out kickstand 104 may have dimensions that are sufficient to support the weight of the mobile computing device when assembled with the mobile device enclosure 100. In one example, the pull-out kickstand 104 may have a same length as the housing 102 and approximately half of the width of the housing 102.

In one example, the pull-out kickstand 104 may be several millimeters (mm) (e.g., 2-5 mm) thick. As a result, it may be difficult for a user to open the pull-out kickstand 104. The pull-out kickstand 104 may be designed to have a slightly larger width and length than the housing 102 that provides an area for the user to pull. However, such a design may not provide a symmetrical design that may be more desirable.

In one example, to allow a symmetrical design wherein the outer perimeter of the pull-out kickstand 104 is flush with the perimeter of the housing 102, a surface enhancement may be added to each side 108 of the outer perimeter of the pull-out kickstand 104. The surface enhancement may increase the amount of friction on the sides 108 of the outer perimeter of the pull-out kickstand 104.

The surface enhancement may enable a user to open the pull-out kickstand 104 with a single hand. For example, the surface enhancement may allow a finger of a user to press against the side 108 of the pull-out kickstand 104 and move the pull-out kickstand 104 with a single hand, rather than using both hands (e.g., one hand to hold the housing 102 and a second hand to pull out the pull-out kickstand 104). In another example, a user may rest the mobile device enclosure 100 on a surface. The surface enhancement may contact or grip the surface and allow a user to pull the housing 102 away from the pull-out kickstand 104 with a single hand to open the pull-out kickstand 104.

In one example, the surface enhancement may be a nano structure that is formed, or added, onto a surface of the sides 108 of the outer perimeter of the pull-out kickstand 104. Further details of the process of forming or adding the nano-structures is discussed in further detail below.

FIG. 2 illustrates a side view of the mobile device enclosure 100 with the surface enhancement. In one example, the housing 102 may include a cut out area 110 that is located around a portion of a perimeter of the housing 102. The cut out area 110 may have dimensions that are approximately the same as the pull-out kickstand 104. As a result, when the pull-out kickstand 104 is disposed in a closed position and resting fully against the housing 102, the pull-out kickstand 104 may rest inside of the cut out area 110 and appear flush with the sides of the housing 102.

In one example, the cut out area 110 may be a full cut out of a lower portion on the back side of the housing 102. For example, the pull-out kickstand 104 may be a full sheet of material. In another example, the cut out area 110 may be disposed around the outer perimeter of the housing 102. For example, the pull-out kickstand 104 may comprise a U-shape that has a hollow center portion.

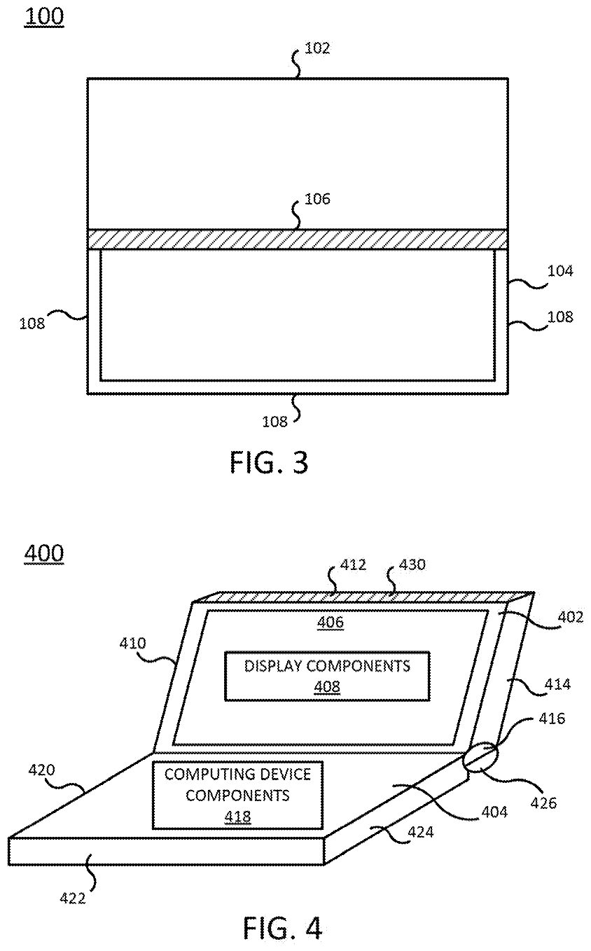

FIG. 3 illustrates a back view of the mobile device enclosure 100 with the surface enhancement. The back view shows the pull-out kickstand 104 in a closed position and resting in the cut out area 110. As a result, an outer surface of the pull-out kickstand 104 may be level with non-cut out area of the housing 102 in the closed position. For example, the outer surface may include the sides 108 with the surface enhancement and a backside of the pull-out kickstand 104. Level may be defined to mean laying on the same plane. In other words, if one were to feel the sides of the housing 102 when the pull-out kickstand 104 is in the closed position, the sides and backside would feel as one continuous surface.

FIG. 4 illustrates an isometric view of another example mobile device enclosure 400 with the surface enhancement. The mobile device enclosure 400 may be a housing for a mobile computing device such as a lap top computer, or any other computing device with a clam-shell design.

In one example, the mobile device enclosure 400 may include a first housing 402 and a second housing 404. The first housing 402 may enclose a display 406 and associated display components 408 (e.g., display substrates, touch screen devices, light arrays, video graphics processors, and the like). The housing 402 may include a left side 410, a front side 412, a right side 414 and a back side 416 located around a perimeter of the first housing 402. The front side 412 may include a surface enhancement to increase an amount of friction on the front side 412 of the first housing 402.

The surface enhancement may be a nano structure that is formed, or added, onto the front side 412 of the first housing 402. The process of forming or adding the nano-structures is discussed in further detail below.

The second housing 404 may enclose a computing device and associated computing device components 418 (e.g., a processor, a memory, a communication bus, a motherboard, interface cards, network cards, and the like). The second housing 404 may include a left side 420, a front side 422, a right side 424 and a back side 426.

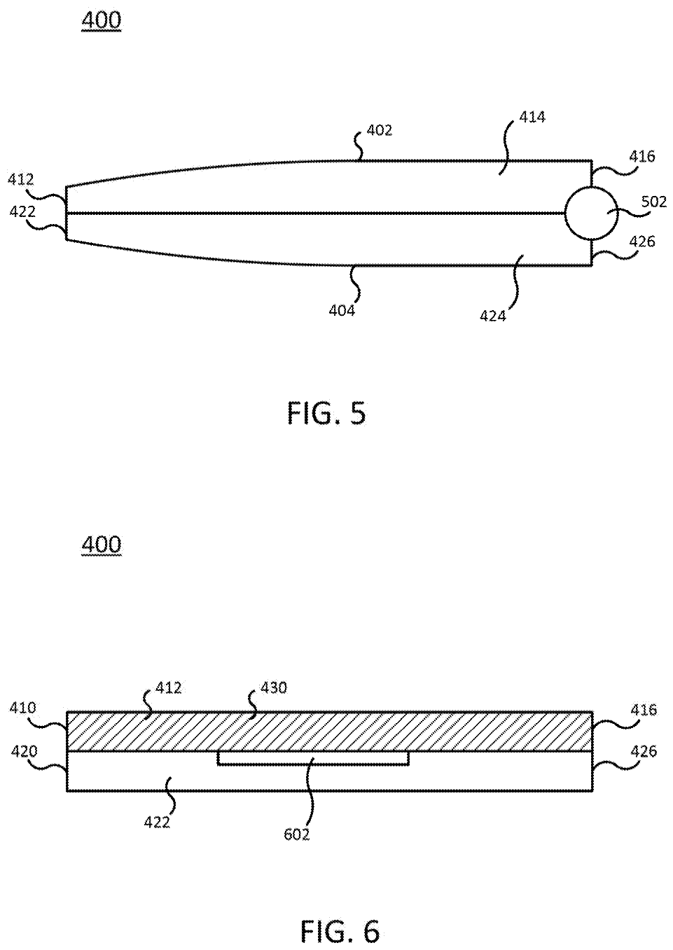

FIG. 5 illustrates a side view of the mobile device enclosure 400 in a closed position. The mobile device enclosure 400 may include a movable hinge 502 to couple the back side 426 of the second housing 404 to the back side 416 of the first housing 402. The movable hinge 502 may rotate to allow the first housing 402 to move away from the second housing 404 to open, or vice versa, to close in a clamshell design.

In one example, the front side 412 of the first housing 402 with the surface enhancement may be level with the front side 422 of the second housing 404 in the closed position. In other words, FIG. 5 illustrates how the surface enhancement does not add any noticeable thickness to the front side 412 of the first housing 402 such that a symmetric design may be maintained.

FIG. 6 illustrates a front view of the mobile device enclosure 400 in a closed position. In one example, the surface enhancement may cover the entire front side 412 of the first housing 402 as shown in FIG. 6. In one example, the surface enhancement may cover a portion, or less than all, of the front side 412 of the first housing 402.

In one example, a finger grip recess 602 may be included in a front side 422 of the second housing 404. The finger grip recess 602 may be a cut out such that a portion of the front side 422 of the second housing 404 does not contact the front side 412 of the first housing 402. Said another way, a portion of a surface of the second housing 404 that faces a surface of the first housing 402 does not touch, or contact, the surface of the first housing 402. The finger grip recess 602 may help a user to open the mobile device enclosure 400 in addition to the surface enhancement on the front side 412 of the first housing.

As a result, the surface enhancement may allow a user to open the mobile device enclosure 400 with a single hand. For example, the user may not have to hold the second housing 404 while trying to pull open the first housing 402. Rather, the second housing 404 may rest on a surface and the user may pull open the first housing 402 with a single hand using the surface enhancement on the first side 412 of the first housing 402.

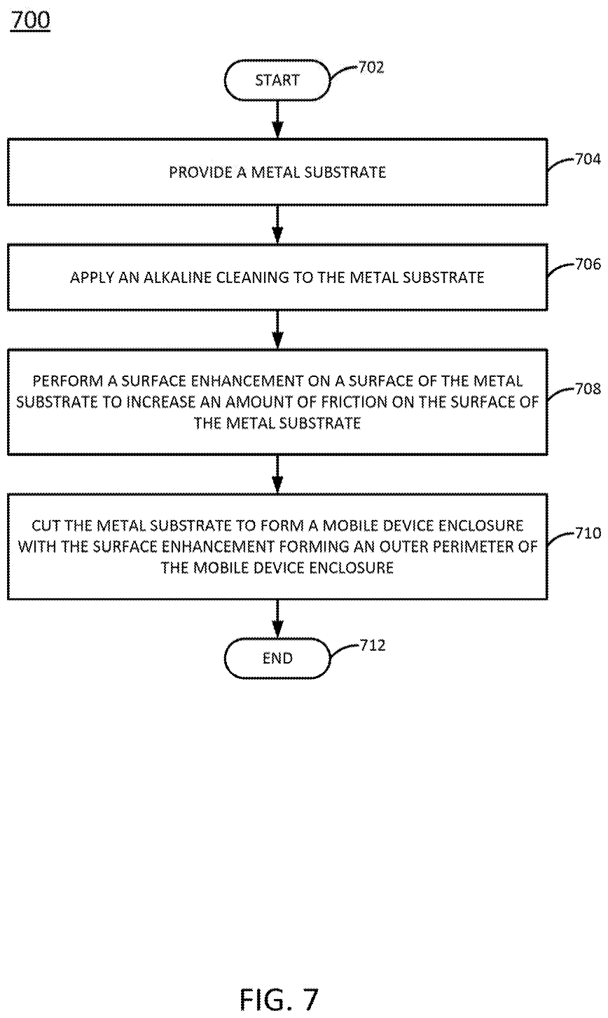

FIG. 7 illustrates a flow diagram of an example method 700 for applying a surface enhancement on a mobile device enclosure. In one example, the method 400 may be performed by a processor, or a controller, that controls operation of equipment, or tools that are part of an assembly line or production facility. In one example, each block may be performed by a different equipment, or tool, in the production line that are controlled by a processor.

At block 702, the method 700 begins. At block 704, the method 700 provides a metal substrate. For example, the metal substrate may be aluminum, magnesium, a metal alloy, and the like, that can be used to fabricate a housing, or enclosure, for a mobile computing device.

At block 706, the method 700 applies an alkaline cleaning to the metal substrate. In one example, the alkaline cleaning may include agents that contain sodium hydroxide or potassium hydroxide in order to remove fats (e.g., grease), oils, protein-based substances, and the like, from the metal substrates. The alkaline cleaning agents may be applied with hot water with an ultrasonic process (e.g., applying ultrasound to the alkaline cleaning agents and/or hot water).

At block 708, the method 700 performs a surface enhancement on a surface of the metal substrate to increase an amount of friction on the surface of the metal substrate, or to increase the coefficient of friction of such a surface of the metal substrate. In one example, the surface enhancement may be an additive process (e.g., nano structures that are formed by growth on a surface) or a reductive or subtractive process (e.g., nano structures that are formed by etching out or cutting from a surface).

In one example, the additive process for the surface enhancement may include performing an acid activation to the metal substrate to create cavities on the surface of the metal substrate. The activation process may use acids such as nitric acid, acetic acid, sulfuric acid, and the like. The acid activation may remove any oxide layer that may form on the surface of the metal substrate.

The acid activation may also remove any alkaline soaps that may remain on the surface of the metal substrate after the alkaline cleaning process in block 706. Oxides and any remaining alkaline soaps remaining on the surface of the metal substrate may cause staining, skip coating, delamination, blistering, or other defects in the process.

The acid activation may also include an NMT chemical bath that contains weak acids. The weak acids may include acids such as, for example, phosphoric acid, carbonic acid, acetic acid, polyacrylic acid, formic acid, or any combination thereof, in a chemical bath. The NMT chemical bath may form a three dimensional coral reef structure with cavities, or nano-pores, in or on the surface of the metal substrate. The nano-pores may have a size in the range of 15-600 nanometers (nm).

After the acid activation, the cavities on the surface of the metal substrate may be filled with a plastic. For example, polyurethane, silicone and/or elastomer resins including 0.5%-5% fluoropolymer materials in the formulation selected from fluorinated olefin-based polymers, fluoroacrylates, fluorosilicone acrylates, fluorourethanes, perfluoropolyethers/perfluoropolyoxetanes, flurotelomers (e.g., C-6 or lower), polytetrafluorethylene (PTFE), fluorosiloxane, fluoro UV polymers, hydrophobic polymers (e.g., C-7 or longer), and the like may be used to fill the cavities.

The plastic may then be cured to bond the plastic to the cavities on the surface of the metal substrate. For example, the plastic may be cured at 60 degrees Celsius (° C.) to 120° C. for 20-40 minutes.

In one example, the reductive process for the surface enhancement may include etching the surface of the metal substrate. For example, any etching process using acid baths may be used.

In some examples, a friction enhancement coating may be applied on top of the surface enhancement. The friction enhancement coating may be a thermoplastic or a rubber material that may be sprayed on or applied via a dip coating process. The friction enhancement may then be cured 60° C. to 120° C. for 20-40 minutes.

At block 710, the method 700 cuts the metal substrate to form a mobile device enclosure with the surface enhancement forming at least a portion of an outer perimeter of the mobile device enclosure. For example, the metal substrate may be sent to a computer numerical control (CNC) process to machine out the metal substrate into the form of the mobile device enclosure 100 or 400. The metal substrate may be cut such that the surface enhancement is located on the sides around a perimeter of a pull-out kickstand (e.g., the pull-out kickstand 104 illustrated in FIGS. 1-3) or a front side of a first housing (e.g., the first housing 402 illustrated in FIGS. 4-6). At block 712, the method 700 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A mobile device enclosure, comprising:
a housing to enclose a computing device; and
a pull-out kickstand coupled to the housing via a movable hinge, wherein an outer perimeter of the pull-out kickstand comprises a surface enhancement to increase an amount of friction on the outer perimeter of the pull-out kickstand.

2. The mobile device enclosure of claim 1, wherein the housing comprises a cut out area, wherein the pull-out kickstand is positioned in the cut out area in a closed position to provide a uniform back surface of the housing and a uniform perimeter of the housing.

3. The mobile device enclosure of claim 2, wherein the cut-out area is located around a portion of a perimeter of the housing.

4. The mobile device enclosure of claim 3, wherein an outer surface of pull-out kickstand with the surface enhancement is level with a non-cut out area of the housing when the pull-out kickstand is in the closed position.

5. The mobile device enclosure of claim 1, wherein the surface enhancement comprises a nano structure formed into a surface of the pull-out kickstand.

6. The mobile device enclosure of claim 1, wherein the surface enhancement comprises a nano structure added onto a surface of the pull-out kickstand.

7. A mobile device enclosure, comprising:
a first housing to enclose a display and associated display components, wherein the first housing comprises a front side, a left side, a right side, and a back side, wherein the front side comprises a surface enhancement to increase an amount of friction on the front side of the first housing; and
a second housing to enclose a computing device and associated computing device components, wherein the second housing comprises a front side, a left side, a right side, and a back side, wherein the back side of the second housing is movably coupled to the back side of the first housing.

8. The mobile device enclosure of claim 7, wherein the front side of the first housing comprising the surface enhancement is level with the front side of the second housing in a closed position.

9. The mobile device enclosure of claim 7, wherein the surface enhancement comprises a nano structure formed into a surface of the front side of the first housing.

10. The mobile device enclosure of claim 7, wherein the surface enhancement comprises a nano structure added onto a surface of the front side of the first housing.

11. The mobile device enclosure of claim 7, comprising a finger grip recess on the front side of the second housing.

12. A method, comprising:
providing a metal substrate;
applying an alkaline cleaning to the metal substrate;
performing a surface enhancement on a surface of the metal substrate to increase an amount of friction on the surface of the metal substrate; and
cutting the metal substrate to form a mobile device enclosure with the surface enhancement forming an outer perimeter of the mobile device enclosure.

13. The method of claim 12, wherein the performing the surface enhancement comprises:
performing an acid activation to the metal substrate to create cavities on the surface of the metal substrate;
filling the cavities on the surface of the metal substrate with a plastic; and
curing the plastic to bond the plastic to the cavities on the surface of the metal substrate.

14. The method of claim 12, wherein the performing the surface enhancement comprises:
etching the surface of the metal substrate.

15. The method of claim 12, further comprising:
applying a friction enhancement coating on top of the surface enhancement; and
curing the friction enhancement coating.
